(19) United States
(12) Patent Application Publication
(10) Pub. No.: US 2008/0093489 A1
(43) Pub. Date: Apr. 24, 2008

(54) Spice Grinder Assembly with Grind Adjusting Wheel

(75) Inventors: Sharon Hadj-Chikh, Buffalo, NY (US); Paul Hatch, Chicago, IL (US); Kristian Buschmann, Chicago, IL (US)

Correspondence Address: Stephen B. Salai, Esq.;Harter, Secrest & Emery LLP, 1600 Bausch & Lomb Place, Rochester, NY, 14604-2711, US

(73) Assignee: Robinson Home Products Inc., Buffalo, NY (US)

(21) Appl. No.: 11/534,614

(22) Filed: Sep. 22, 2006

(51) Int. Cl. A47J 42/00; A23L 1/223

(52) U.S. Cl. 241/169.1; 426/638

(57) ABSTRACT

A spice grinder assembly is provided having a converging chute for introducing spices and an adjusting wheel for setting a resulting grind. The adjusting wheel is accessible through a side of a housing of the spice grinder assembly.

### BACKGROUND OF THE INVENTION

1. Field of the Invention

The present invention generally relates to a spice grinder assembly, and more particularly to a spice grinder assembly having a laterally accessible adjusting wheel for varying the size of a resulting grind, and a converging inlet port for introducing whole or partially cracked spices into the spice grinder assembly.

2. Description of Related Art

Seasonings are an integral component to many prepared foods. The freshness and robustness of a seasoning is often related to its duration in a given state. For pepper, for example, it has been found advantageous to retain the pepper as whole peppercorns, wherein the peppercorns are ground into a finer powder (a grind) only when required.

Pepper grinders have been provided for retaining a volume of whole peppercorns within the pepper grinder and selectively grinding the peppercorns in response to an immediate demand.

However, the need exists for allowing a user to easily and relatively accurately select the coarseness of the resulting grind. The need also exists for expedient introduction of whole spices into the grinder. The need further exists for retaining excess grind in the grinder upon completion of grinding. The need still further exists for maintaining a grind adjustment when additional spices are to be introduced into the grinder.

### BRIEF SUMMARY OF THE INVENTION

The present invention provides a spice grinder assembly having a readily accessible adjusting wheel for varying the size of the resulting grind. One configuration of the spice grinder assembly further contemplates a generally funnel shaped or converging inlet port for introducing spices into the spice grinder assembly.

In one configuration, the present invention includes a spice grinder assembly having an upper housing including an inlet port for introducing spices and a pass-through port for passing the spices. The spice grinder assembly further includes a lower housing rotatably connected to the upper housing, the lower housing having an entrance port connected to the pass-through port, a spaced outlet port and an access port intermediate the entrance port and the outlet port. The access port is exposed to a lateral or side of the lower housing.

A grinder mechanism is located within the lower housing, wherein the grinder mechanism includes a grinding face, a grinding wheel and an adjusting wheel bearing against one of the grinding face and the grinding wheel. The adjusting wheel varies a spacing between the grinding wheel and the grinding face and is exposed through the access port. A turning rod extends within the upper housing and the lower housing to impart rotation to the grinder mechanism upon rotation of the upper housing relative to the lower housing.

In a further configuration, the inlet port of the spice grinder assembly includes a converging chute or funnel. A stopper can be releasably connected to the turning rod to selectively occlude the inlet port. It is further contemplated that the access port can be proximal to the outlet port of the lower housing. Also, indicia corresponding to a resulting grind can be located proximal to the access port.

### BRIEF DESCRIPTION OF THE SEVERAL VIEWS OF THE DRAWING(S)

FIG. 1 is a front elevational view of a first configuration of the spice grinder assembly.

FIG. 2 is a rear elevational view of the spice grinder assembly of FIG. 1.

FIG. 3 is a left side elevational view of the spice grinder assembly of FIG. 1, wherein the right side elevational view is a mirror image thereof.

FIG. 4 is a top plan view of the spice grinder assembly of FIG. 1.

FIG. 5 is a bottom plan view of the spice grinder assembly of FIG. 1.

FIG. 6 is a front elevational view of a second configuration of the spice grinder assembly.

FIG. 7 is a rear elevational view of the spice grinder assembly of FIG. 6.

FIG. 8 is a left side elevational view of the spice grinder assembly of FIG. 6.

FIG. 9 is a top plan view of the spice grinder assembly of FIG. 6.

FIG. 10 is a bottom plan view of the spice grinder assembly of FIG. 6.

FIG. 11 is an exploded elevational view of the components of the spice grinder assembly.

### DETAILED DESCRIPTION OF THE INVENTION

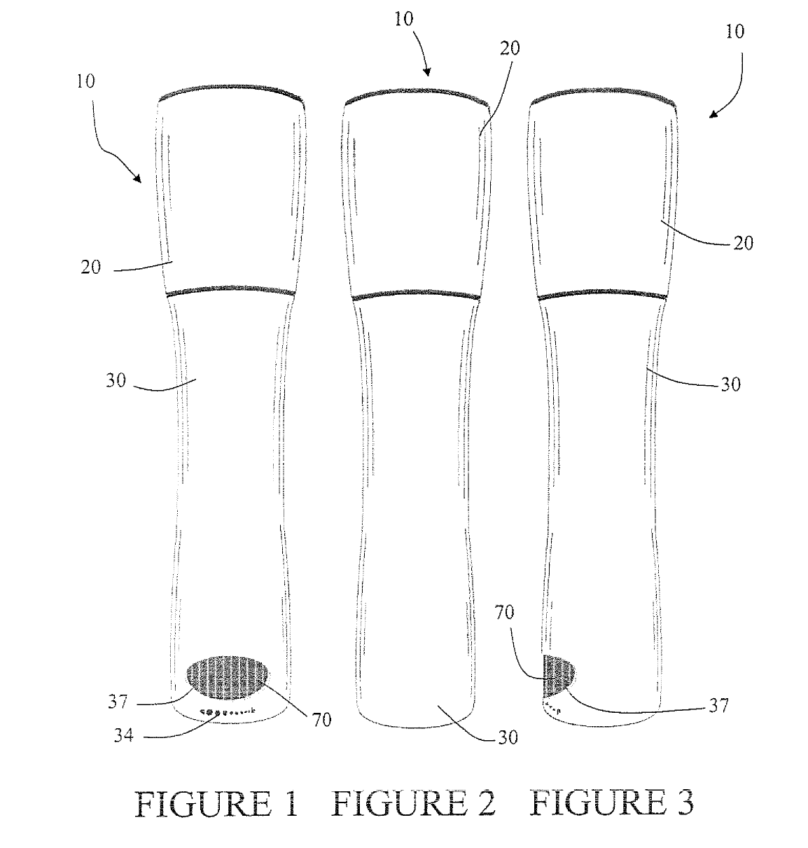

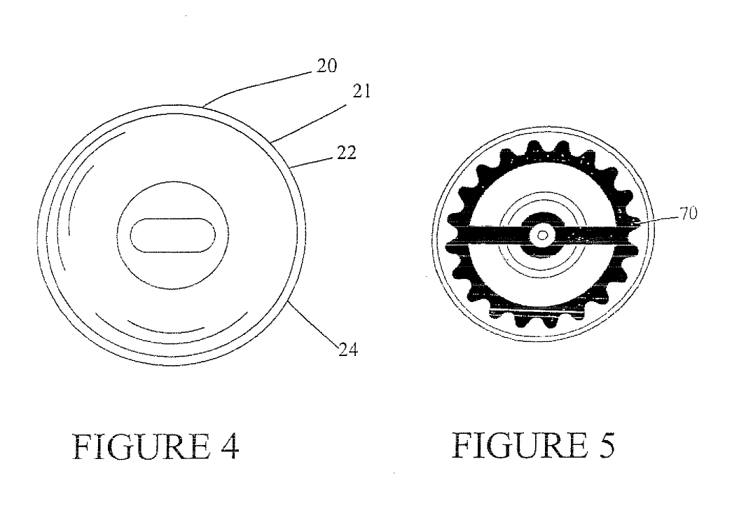

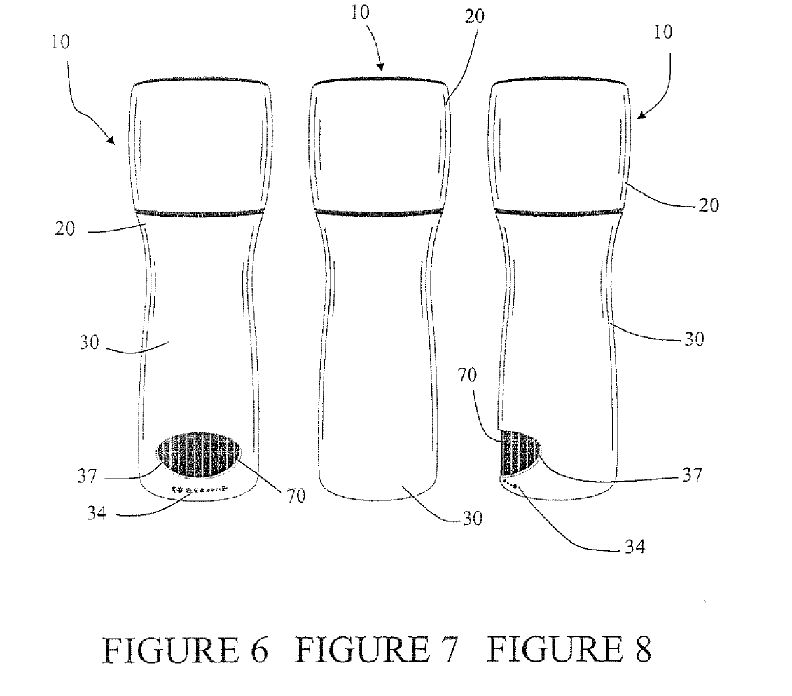

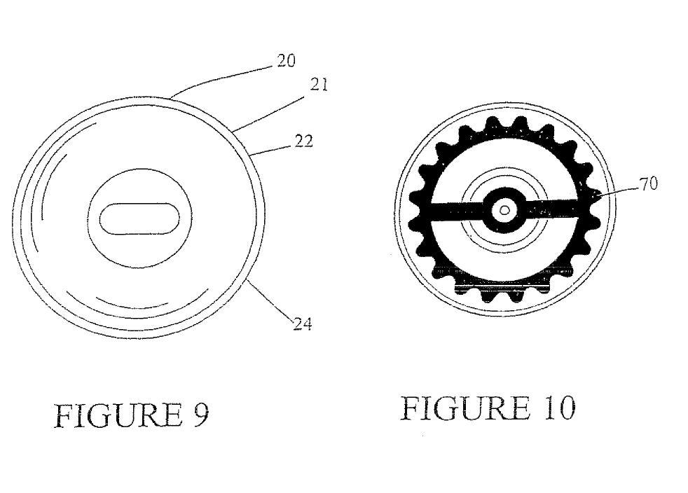

Referring to FIGS. 1-11, a spice grinder assembly 10 includes an upper housing 20 rotatably attached to a lower housing 30. The upper housing 20 and the lower housing 30 can be formed from any of a variety of materials including composites, laminates, plastics, thermoplastics, thermosetting materials, metals, alloys and ceramics. A satisfactory material has found to be stainless steel, and specifically 18/8 stainless steel (approximately 18% chromium and 8% nickel). Any of these materials also may be used to form the upper housing 20 and the lower housing 30. For example, the upper housing 20 and the lower housing 30 may have an exterior surface of metal, with a liner of, e.g., thermoplastics. Such a construction may be beneficial when spices such as salt are used that could potentially react with a metallic surface.

The upper housing 20 and lower housing 30 preferably form a grinder that can be stood on either its top or bottom. As shown in FIGS. 1-3 and 6-9, for example, the preferred grinder is a generally contoured cylinder with both the top and bottom being substantially flat. In this manner, the grinder may be placed on its bottom for access to the top of the upper housing 20, or the grinder may be placed on its top to keep loose grinds from soiling a countertop or the like when the grinder is not in use.

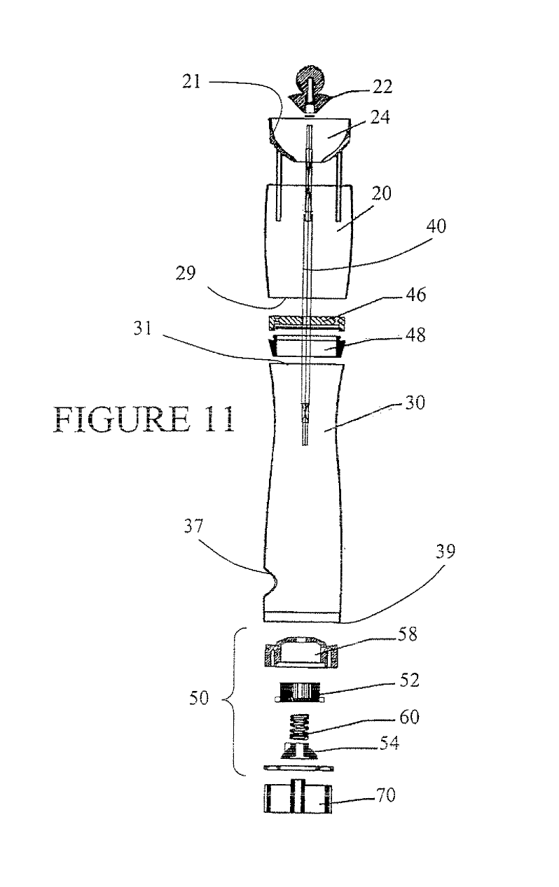

Referring to FIG. 11, it is contemplated an optional coupler can be located intermediate the upper housing 20 and the lower housing 30, wherein the coupler includes one or more rings 46, 48 for providing a rotating interface between the upper housing 20 and the lower housing 30.

The upper housing 20 includes an inlet port 21 for introducing spices and a pass-through port 29 for passing the spices from the upper housing. The inlet port 21 of the upper housing 20 includes a guidedly converging guide chute 24 for introducing spices into the spice grinder 10. The converging structure of the chute 24 can be generally funnel shaped, such as but not limited to conical, frustoconical, curvilinear or faceted. The converging chute 24 facilitates easy introduction of spices into the grinder, without the need for an accessory funnel. In one configuration, the chute 24 converges from an opening diameter substantially equal to a diameter of the adjacent upper housing 20, to a terminal diameter typically less than one-half the opening diameter. In this configuration, the opening diameter of the chute 24 preferably is in the range of from about 1.5 inches to about 3 inches, and more preferably from about 2 inches to 2.5 inches. The terminal diameter of the chute 24 preferably is in the range of from about 0.5 inches to 1.5 inches and more preferably from about 0.75 inches to about 1.25 inches. So formed, the grinder accepts all manner of spices, including relatively larger spices, such as allspice.

A stopper 22 cooperatively engages the chute 24 to preclude passage through the inlet port 21. In preferred construction, the stopper 22 is operably located adjacent the terminal diameter of the chute 24 and threadable onto a turning rod 40 (described below).

As seen in FIGS. 1-3 and 6-8, the upper housing 20, the chute 24 and the stopper 22 are configured to dispose the stopper within the vertical dimension of the housing 20. That is, the vertical dimension of the spice grinder assembly 10 is defined by a top surface of the upper housing 20. The top surface of the upper housing 20 is a substantially planar surface, orthogonal to a longitudinal dimension of the spice grinder assembly 10, such that the grinder may be stood on either its top or bottom. However, it is understood the stopper 22 can be operably located to occlude the chute 24 at the opening diameter of the chute. In this configuration, the grinder may not be stood on its top, or the stopper 22 may be formed such that the grinder may be rested thereon when not in use

The lower housing 30 includes an entrance port 31 connected to the pass-through port 29 of the upper housing 20. The lower housing 30 further includes an outlet port 39 spaced from the entrance port 31, and an access port 37 intermediate the outlet port and the entrance port. In one configuration, the lower housing 30 has a generally cylindrical configuration including a vertically extending peripheral wall, wherein the entrance port 31 is at an upper end of the lower housing and the outlet port 39 is at a bottom end of the lower housing. The access port 37 is in a side of the peripheral wall of the lower housing 30, as seen in FIGS. 1, 6 and 11. Thus, as the entrance port 31 and the outlet port 39 are disposed at the ends of the lower housing 30, the access port 37 is generally perpendicular to the entrance port and the outlet port.

The turning rod 40 extends within the upper housing 20 and the lower housing 30. As noted above, the stopper 22 releasably engages the turning rod 40, such as by cooperating threads. However, it is understood alternative connections such as detent or friction fit can be employed to operably connect the stopper 22 and the turning rod 40.

Referring to FIG. 11, a grinder mechanism 50 is located within the lower housing 30. It is understood any of a variety of grinder mechanisms 50 can be employed, and that the relative location of the components of the grinder mechanism can be changed without departing from the present invention. For purposes of description a representative grinder mechanism 50 is set forth below in detail.

An annular seat 58 is disposed within the lower housing 30 and retained by friction fit or bonding. The seat is sized to locate the grinder mechanism 50 within the lower housing. The seat 58 can be integrated into the grinder mechanism 50 as shown, or can be a separate component. It is further contemplated the seat 58 can be integrally formed in the lower housing 30, independent of the grinder mechanism 50. The grinder mechanism 50 includes a static portion 51 having a grinding face 52 and a grinding wheel 54. The static portion 51, and thus the grinding face 52, is connected to the lower housing 30 by means of the seat 58. The grinding face 52 preferably is cylindrically inwardly facing. In one configuration, the grinding face 52 is disposed within the lower housing 30 intermediate the access port 37 and the entrance port 31.

The grinding wheel 54 is connected to the turning rod 40, and a bias mechanism 60, such as a coil spring, is disposed concentrically about the turning rod 40 and intermediate the grinding wheel 54 and the annular seat 58. The grinding wheel 54 is connected to the turning rod 40 for rotation therewith and is translatable along the rod 40. For example, the rod may have a substantially square cross-section and the grinding wheel 54 has a square aperture for receiving the shaft. The bias mechanism 60 urges the grinding wheel 54 away from the static portion 51.

An adjusting wheel 70 is disposed about the turning rod 40 and either directly or indirectly interfaces with the grinding wheel 54 to urge the grinding wheel 54 against the bias mechanism 60 and toward the grinding face 52. Preferably, the adjusting wheel is threadably engaged with the turning rod 40. The adjusting wheel 70 is located within the lower housing 30 such that an outer surface thereof is exposed through the access port 37 for actuation through the access port. In one configuration, the adjusting wheel 70 includes a plurality of peripheral or surface features, textures, grooves, ridges, ribs or the like to facilitate engagement by the operator so that the adjusting wheel can be rotated on the shaft 40 relative to the lower housing 30, and hence, the grinding face 52.

As shown, it is generally preferred that the adjusting wheel 70 is slightly recessed from the adjacent surface of the lower housing 30, such that use of the grinder does not result in inadvertent adjustment of the adjusting wheel 70. However, it is understood the exposed portion of the adjusting wheel can be substantially flush with or project from the adjacent portion of the lower housing.

Further, a detent can be operably connected to the adjusting wheel 70 so that the relative position of the adjusting wheel remains constant, absent operator intervention. Alternatively, rotation of the adjusting wheel 70 can be against sufficient friction to substantially preclude unintended rotation of the adjusting wheel.

Rotation of the adjusting wheel 70 with respect to the shaft varies the size of the resulting grind, such as by varying the separation of the grinding face 52 and the grinding wheel 54. As should be appreciated, the adjustment wheel is independent of the stopper, thus remedying a common deficiency of conventional grinders. In particular, the stopper may be removed and spices refilled without adjusting the grind. In contrast, many conventional grinders incorporate the grind adjustment into the means for removing the portion of the grinder that exposes the opening for receiving the spices.

As the adjusting wheel 70 is exposed on the exterior of the lower housing 30, adjustment of the grind can be readily made without having to invert the spice grinder assembly 10 or employ separate tools. Further, the diameter of the adjusting wheel 70 can be selected to provide substantial mechanical advantage to the user, thereby reducing the force necessary to set the grind.

In operation, the stopper 22 is removed from the inlet port 21 thereby providing flow through the chute 24. As described above, the chute 24 preferably has a funnel shape facilitation easy pouring of the spice to be ground into the grinder. A plurality of spices can be disposed within conveying chute 24 and pass by gravity through the terminal end of the chute into the upper housing 20, through the pass-through port 29 and into the lower housing 30 to settle atop the grinder mechanism 50. Referring to FIG. 11, as the terminal end of the chute 24 is a relatively large port, whole spices, as well as larger spices, such as whole Allspice, can be introduced into the spice grinder assembly 10.

Rotation of the lower housing 30 relative to the upper housing 20 causes rotation of the shaft, and thus causes the grinding wheel 54 to rotate relative to the grinding face 52 thereby crushing or grinding the spices disposed therebetween, as known in the art.

To adjust the coarseness or size of the resulting grind, the adjusting wheel 70 is contacted through the access port 37 and rotated by engagement with the thumb or finger of an operator to dispose the grinding wheel 54 closer to the grinding face 52, to reduce the grind size, or away from the grinding face to increase the resulting grind size. Moreover, because the adjustment wheel is accessible from the side of the grinder, the grind may be adjusted during use.

As seen in the figures, the lower housing 30 can include indicia 34 corresponding to the resulting grind. The indicia is shown in phantom, as the particular design or configuration of the indicia does not form a portion of the invention. Upon viewing the indicia 34, the user can readily rotate the adjusting wheel 70 to provide a coarser or finer grind of the spices. Therefore, the spice grinder assembly 10 allows the user to maintain an operable (vertical) orientation of the assembly while adjusting the grind and visually confirming the grind.

Upon dispensing the desired amount of spice, the grinder is placed on a countertop, tabletop, or similar surface. However, grinds remaining in the bottom housing may inadvertently drop to the surface, creating a mess that must be wiped or otherwise cleaned up. The preferred grinder, however, has a generally contoured cylindrical shape that facilitates standing the grinder on either the top or bottom. More specifically, as the top surface of the upper housing 20 is planar, the pepper grinder assembly 10 can be disposed in the stable upright orientation, seen in FIGS. 1-3 and 6-8, or in a stable inverted orientation. By storing the grinder in the inverted orientation, ground spices will not soil the counter. To maintain stability of the grinder in both the normal and inverted positions, the upper housing 20, the lower housing 30, and the grinder mechanism 50 are configured to locate a center of mass of the grinder within a middle third of the height of the assembly.

While the invention has been described in conjunction with specific embodiments thereof, it is evident that many alternatives, modifications, and variations will be apparent to those skilled in the art in light of the foregoing description. Accordingly, the present invention is intended to embrace all such alternatives, modifications, and variations as fall within the spirit and broad scope of the appended claims.

1. A spice grinder assembly comprising:
an upper housing having an inlet port for introducing spices and a pass-through port for passing the spices;
a lower housing rotatably connected to the upper housing, the lower housing having an entrance port connected to the pass-through port, a spaced outlet port and an access port intermediate the entrance port and the outlet port;
a turning rod extending within the upper housing and the lower housing, the turning rod being fixed relative to one of the upper housing and the lower housing and being rotatable relative to the other of the upper housing and the lower housing;
a grinder mechanism within the lower housing, at least a portion of the grinder mechanism being connected to the turning rod; and
an adjusting wheel operably connected to the grinder mechanism, the adjusting grinding wheel varying a resulting grind of the grinder mechanism, the adjusting wheel exposed through the access port.

2. The spice grinder assembly of claim 1, wherein the grinder mechanism includes a grinding face and a grinding wheel, the adjusting wheel bearing against one of the grinding face and the grinding wheel, the adjusting wheel varying a spacing between the grinding wheel and the grinding face.

3. The spice grinder assembly of claim 1, wherein the inlet port includes a converging chute.

4. The spice grinder assembly of claim 1, wherein the inlet port includes a converging surface.

5. The spice grinder assembly of claim 4, further comprising a stopper sized to include the inlet port, the stopper connected to the turning rod.

6. The spice grinder assembly of claim 1, further comprising a bias mechanism intermediate the grinding face and the grinding wheel.

7. The spice grinder assembly of claim 6, wherein the bias mechanism comprises a helical spring.

8. The spice grinder assembly of claim 1, wherein the access port is proximal to the outlet port of the lower housing.

9. The spice grinder assembly of claim 1, wherein the grinder mechanism includes a grinding face secured to the lower housing and a grinding wheel connected to the turning rod for rotation with the turning rod.

10. The spice grinder assembly of claim 1, further comprising indicia on the lower housing, the indicia proximal to the access port and corresponding to a resulting grind.

11. The spice grinder assembly of claim 1, wherein the lower housing includes a generally peripheral wall, the access port located in the peripheral wall.

12. (canceled)
